(19) United States
(12) Patent Application Publication
(10) Pub. No.: US 2010/0315315 A1
(43) Pub. Date: Dec. 16, 2010

(54) OPTIMAL GRAPHICS PANELIZATION FOR MOBILE DISPLAYS

(76) Inventor: John Osborne, Incline Village, NV (US)

Correspondence Address: IAN F. BURNS & ASSOCIATES, 4790 Caughlin Parkway #701, RENO, NV, 89519-0907, US

(21) Appl. No.: 12/795,347

(22) Filed: Jun. 7, 2010

Related U.S. Application Data
(60) Provisional application No. 61/186,344, filed on Jun. 11, 2009.

(51) Int. Cl. G09G 5/00

(52) U.S. Cl. 345/1.3

(57) ABSTRACT

A system and method for panelizing an image allows the image to be provided to a mobile device and viewed panel by panel in accordance with a panel sequence. The image is initially processed to locate panels within the image. An optimal panel size is then determined which may be, for example, the most common panel size of the panels of the original image. The original panels are converted to a second set of panels of the optimal panel size, by reducing, enlarging or subdividing the original panels. A panel sequence is then applied that determines an order for viewing the panels. When the image is requested by a mobile device, the panels may be resized to a screen size of the device so that whole panels may be displayed. Navigating to the next panel may be made by reference to the panel sequence using the device interface.

### CROSS REFERENCE TO RELATED APPLICATIONS

This application claims priority to U.S. provisional patent application Ser. No. 61/186,344, filed Jun. 11, 2010, the contents of which is herein incorporated by reference.

### FIELD OF THE INVENTION

The present invention relates generally to the fields of computer systems, graphic arts, and in particular graphical user interfaces in mobile devices.

### BACKGROUND OF THE INVENTION

As mobile devices become more capable and connected to high speed digital networks, more diverse types of media are being made available to the devices. Their small screens, however, make the display of some media forms less than optimal. The traditional means for displaying graphical elements or pictures, for example, is to display them in a generic Web browser utilizing pan and zoom capability to give a blurred or otherwise poorly rendered image of the overall graphic, and then allow the user to zoom into areas of interest. One example of this is taught by Fischer, et al. (U.S. Pat. No. 7,489,821). For various types of images, such as cartoons, comic strips, and similarly paneled images, this technique fails to provide the overall detail that the graphic artist is attempting to portray, and zooming in can be a tedious task because the graphical panels may or may not be atomic. Zooming into the corner of four panels, for example, provides little useful information.

### SUMMARY OF EMBODIMENTS OF THE INVENTION

### Advantages of One or More Embodiments of the Present Invention

The various embodiments of the present invention may, but do not necessarily, achieve one or more of the following advantages:

the ability to divide an image in a way that sensible viewing of the image can be maintained;

the ability to panelize an image in a way that makes it viewable on a small display screen, such as of a mobile device;

the ability to view cartoons, comic strips and the like on a mobile display device; and

the ability to configure parts of an image for viewing on a mobile display device with minimal need for pixel scrolling.

These and other advantages may be realized by reference to the remaining portions of the specification, claims, and abstract.

### SUMMARY OF THE INVENTION

One of several purposes of this invention is to provide an automated process whereby an arbitrary graphical entity, for example an image comprised of sub-panels (often used in political or entertainment cartoons) may be effectively panelized such that the user experience of viewing the graphic is optimized for minimal user interaction and maximal display of each graphic sub-panel.

In a first aspect, the present invention provides a system and method for panelizing an image. To panelize an image, a first plurality of panels may be located within the image. From these panels, an optimal panel size may be determined. The optimal panel size may be used as the basis for converting the first plurality of panels to a second plurality of panels, for example by reducing, enlarging or subdivided one or more of the first plurality of panels. A sequence of the converted panels can then be determined and stored in association with the converted panels.

In a further aspect, the present invention provides a system for providing an image to a display device. The system includes a server and a database operatively associated with the server. The database may store a plurality of panels corresponding to the image and a panel sequence corresponding to the plurality of panels. The server may be configured to receive a request for the image from a display device, retrieve at least one panel of the image from the database and provide the at least one panel to the display device.

In a further aspect, the present invention provides a method for providing an image to a display device. The image may be divided into a plurality of panels having an associated panel sequence. The panels and the panel sequence may be provided to the display device, thereby allowing the display device to display the panels one at a time as determined by the panel sequence.

In a further aspect, the present invention provides a method for displaying an image on a mobile display device. The mobile display device may request an image from the server and receive panels corresponding to the image into the display device. A first panel may be received and displayed and then navigation commands entered by a user may be processed locally or at the server with reference to a panel sequence to cause one or more other panels of the image to be displayed.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one preferred embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF DRAWINGS

FIG. 1 is substantially a schematic of a system for panelizing images and providing panelized images to a mobile device;

FIG. 2 substantially depicts a method for panelizing an image;

FIG. 3 substantially depicts an image to be panelized;

FIG. 4 substantially depicts the image of FIG. 3 after panel detection;

FIG. 5 substantially depicts a histogram of panel sizes of FIG. 4;

FIG. 6 substantially depicts the image of FIG. 4 after subdivision of panels and with an overlaid panel sequence; and

FIG. 7 substantially depicts an image showing a panel sequence including subdivided panels.

### DESCRIPTION OF PREFERRED EMBODIMENTS

In the following detailed description of the preferred embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

Turning now descriptively to the drawings, in which similar reference characters denote similar elements throughout several views, the attached figures illustrate systems and methods for graphics panelization for mobile displays.

As mentioned above, the commonly used pan and zoom functions are not optimal for use with displaying some forms of graphical pages such as cartoons, comics, and similarly tiled displays containing a number of panels, in particular where the panels within an image are irregularly sized and/or irregularly arranged within the complete image. In a system and method according to the present invention, a graphical image is analyzed to determine the location and sizes of panels within the image. The panels are then sized to an optimal size, including subdividing overly large panels, and a sequence of the panels is then mapped. The mapping of the panels allows a viewer to traverse the graphical images by viewing individual panels in a sequential and logical order on a display device, which may be more appropriate than viewing the entire image using pan, zoom and pixel scrolling techniques.

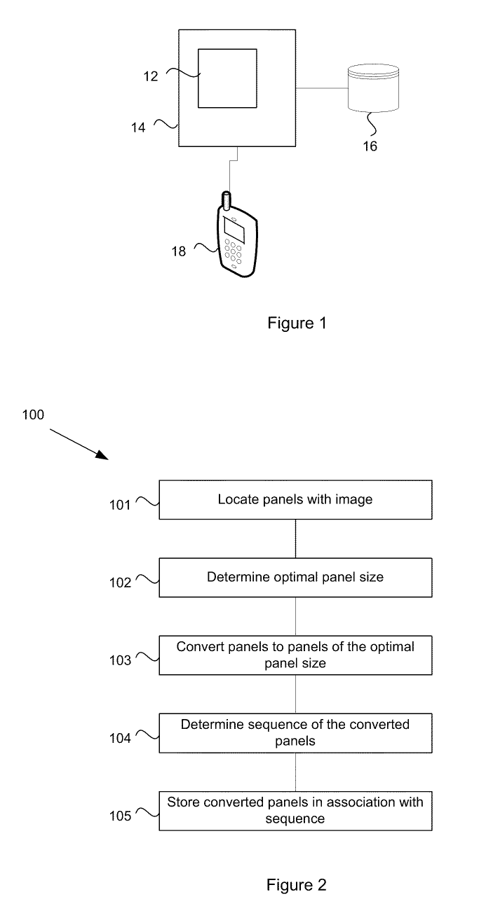

The panelization method outlined above may be performed by an application 12 or similar processing function executing on a processor of a server 14 or computer terminal, as shown in FIG. 1. The server 14 may be operatively associated with a database 16. The server 14 may also be configured to provide data services to one or more mobile devices 18. It is considered that the provision of data services to mobile devices is well known and no further description of these aspects are required herein.

A flowchart depicting a graphics panelization method is illustrated at 100 in FIG. 2. At step 101, a plurality of panels are located within an image. These panels are analyzed (step 102) to determine an optimal panel size. At step 103, the panels are converted to a set of panels of the optimal panel size. A sequence or thematic map of the converted panels is then determined (step 104) and stored, e.g. in a database, in association with the converted panels (step 105).

Converting the image panels to panels of the optimal panel size may include enlarging a panel, reducing a panel or subdividing a panel into multiple smaller panels (subdivision panels) of the optimal panel size. Other panel conversions may be apparent to a person skilled in the art and are intended to be encompassed herein.

When a display device requests the image, e.g. from a server, the server retrieves the panels and the panel sequence from the database and transmits them to the device for display. The panels may be transmitted all together or they may be transmitted one at a time in response to navigation commands from the device. In one embodiment, the image request to the server may be used to identify the device type and correspondingly, the display parameters of the device. For example, the device request may indicate the type of device, from which the server may determine the display parameters by reference to a local look-up table or database. In an alternative arrangement, the request may specifically indicate the display parameters for the device. Once the display parameters have been determined, the server may scale the panel images to a size matching the display device before transmitting the panels to the device. Alternatively, re-scaling of the panels may be performed at the device, although this is more computationally intensive for the display device.

When the panels are received into the device, the panels are displayed at a size that is suitable for the device. That is, whole panels are displayed on the screen so that no pixel scrolling is required to view a single panel. The panels are received together with the panel map. An initial panel may be displayed, whether it be the first panel in the sequence, a central panel, or some other panel. A navigation interface may then be provided for traversing the entire image by sequentially moving through the panels. The sequential traversing of the panels helps to ensure a more logical and consistent message of the panels is conveyed than can be achieved using the conventional pan and zoom methods. In one embodiment, the user interface is designed to traverse the panels in a manner that is as intuitive and consistent with the mobile device's GUI methodology as possible. If, for example, the mobile device uses a touch screen and sliding gesture to normally activate a pixel by pixel scroll command, this same gesture could be used to implement the traversal to the next panel instead. If a joystick type interface or Left/Right/Up/Down buttons are normally used for scrolling in the device, these similar interface command structures may be incorporated such that they are used in the panel traversal command interface as well. This common user interface methodology, combined with the visual cues provided by the panelization to indicate nominal traversal directions, provides a clear and intuitive traversal mechanism. Other traversal mechanisms can also be implemented to assist the user. For example if only one traversal direction is allowed in the thematic map, pressing any scroll key could advance the panel without the user having to look for the proper key.

In one embodiment, the optimal panel size is determined to be the most common panel size of the panels located in the original image. In alternative embodiments, the optimal panel size may be the largest panel size, the smallest panel size, or an average panel size. In alternative embodiments, the optimal panel size may be specified by a display size of a display device. Other methods for determining the panel size will be apparent to a person skilled in the art.

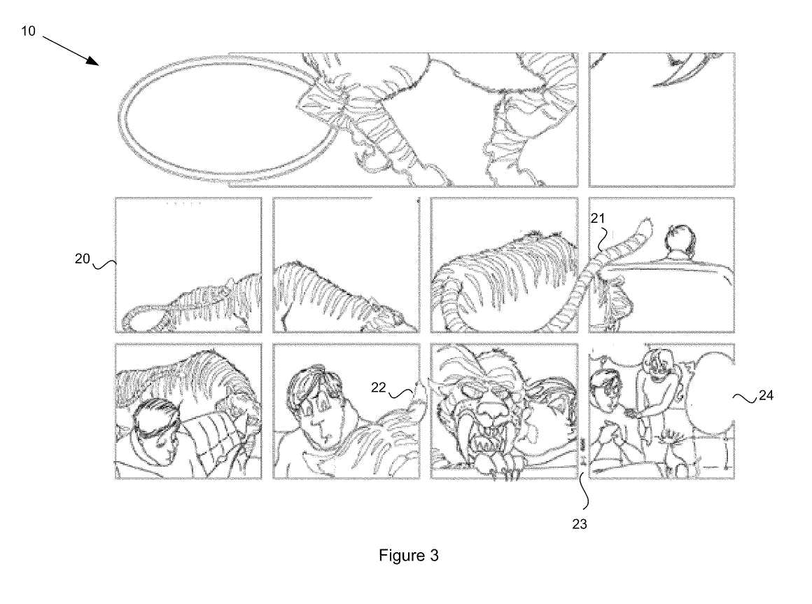

An example of the above described method will now be described with reference to FIG. 3 which shows an original image 10 comprising a collection of cartoon panels 20.

In one preferred embodiment, the color graphic image is first subjected to edge detection to reduce the complexity of the image. Those familiar in the art will recognize that a number of different algorithms and techniques are available for edge detection, such as Sobel or Canny It must be noted that because the artist sometimes uses artistic license with regard to the boundaries, it is possible that two or more panels will be joined by an overlapping graphical element 21 or that some graphical elements will overlap or extend past the boundaries 22 or that non graphical elements such as copyright, author, or date information will be entered into the margins 23. It is also possible that the boundary might be discontinuous 24.

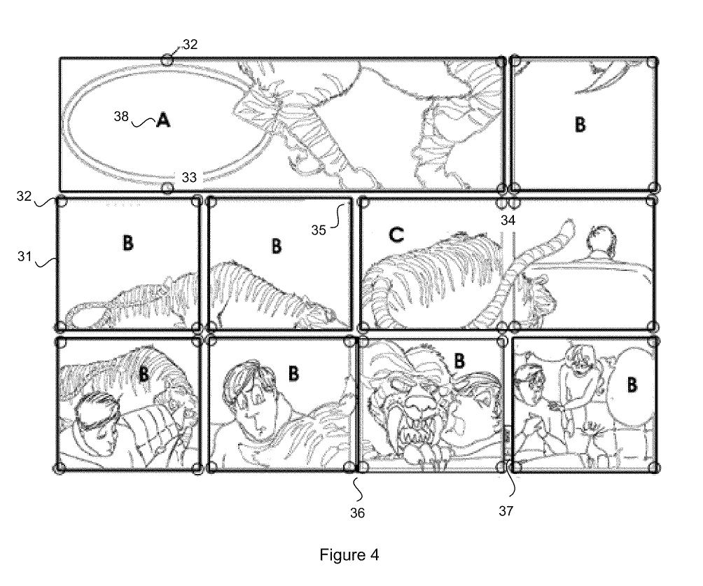

Once the edge detection is complete, panel detection is initiated, as shown in FIG. 4. Those familiar with the art will recognize that again a number of different algorithms and approaches can be used to affect the same outcome, such as a Lee/Moore nearest neighbor algorithm, Hightower probe search, or scanning windows. In one preferred embodiment, scanning for the contiguous outline of a framed image might be used, in another preferred embodiment searching for rectilinear corners could be used, or neural network pattern recognition, or a combination of techniques. Scanning for bounding rectangles with nearest neighbor approaches has the benefit of finding graphical elements that extrude beyond the panel's usual border outline or cross between panels, while corner searches have the benefit of finding rectangles that may be incomplete or discontinuous. In FIG. 4, the final bounding boxes are shown in dark outline 31 and detected corners are shown by circles 32. From this drawing several common characteristics can be seen. Not all corners correspond to a bounding box 33, several panels may become grouped because of overlapping graphical elements 34, a bounding box may be missing corners 35, some bounding rectangles might overlap 36, and some boxes may be very small in comparison 37.

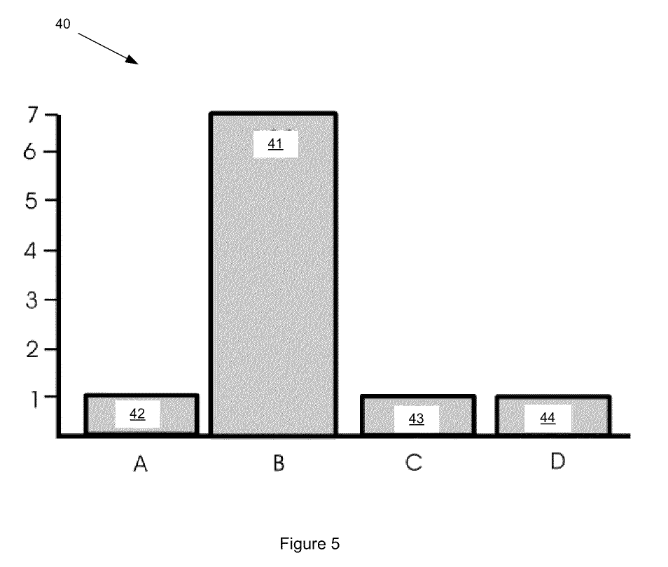

Once the panels have been located, a panel size may be attributed to each panel. In FIG. 4, there are four distinct panel sizes denoted by letters A, B, C and D. These panel sizes may be calculated by reference to the bounding box 31, the corners 32 or other attributes and combinations of attributes of the panels. FIG. 5 shows a histogram 40 for the panels analyzed in FIG. 4. Panels are binned according to an over/under criterion, and overly large or small detections are cut off in this process. If a panel is within 10% of the average X and Y value stored for a particular bin, the panel is added to that bin and the average is updated. The percentage given is for example only, not to constrain the implementation of the algorithm. Those familiar with the art will recognize that a wide variation on the over/under criterion could yield essentially similar results, and for a particular set of inputs different values might be used. Text embedded within the graphic might be seen as a particularly thin panel or a series of very small panels. Errors in correlation might yield a very large panel, essentially the size of the entire graphic. These small and large panels may be dropped as errors.

After panel sizes have been calculated, an optimal panel size can be determined. The optimal panel size represents the panel size to which all panels will be converted (e.g. enlarged, reduced or sub-divided) so that when the panels are subsequently provided to a display device, whole panels are displayed with minimal need for pixel scrolling. In one embodiment, the optimal panel size is chosen to be the most common panel size appearing in the original image. The most common panel size may be considered optimal because, by scaling to this panel size, the least number of conversions needs to be performed. As described above, other methods may be used for determining the optimal panel size. The most common panel size may be determined by frequency heuristic, as shown by the histogram 40 of FIG. 5, in which panel size B 41 is most common while panel sizes A 42, C 43 and D 44 are less common.

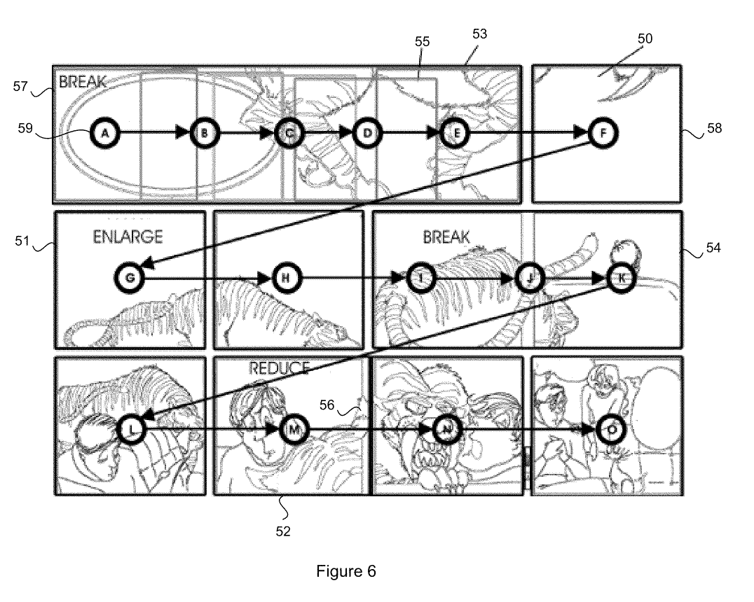

FIG. 6 shows each panel with an identifier that indicates the action to panelize the graphic. Panel 50 is already at the optimal panel size and so no action is required. Panel 51 requires enlargement. Panel 52 has a bounding box equivalent to the optimally sized panel 50 but includes elements 56 that extend beyond the panel and so is required to be reduced so that all display features of the panel fit within the optimal panel size. Panel 53 is too large to reduce to the optimally sized panel 50 without losing detail, and so a Break action must be performed to sub-divide the panel into panels of the optimal panel size. Panels which might otherwise be considered as unique but have graphical elements crossing from one to another are treated as one large panel 54. Panel 54 is thus indicated as needing to be sub-divided. Panels may have overlapping bounding boxes caused by elements that cross the panel boundary but do not directly intersect the other panel's outline.

Panels that require subdividing may be subdivided into panels of the optimal panel size. A panel may require either vertical subdivision, horizontal subdivision or both. In the example shown, panel 53 shown in FIG. 6 is subdivided into five individual panels, e.g. panel 55, which are at the optimal panel size. For a horizontal subdivision, the optimal panel size is first applied to the leftmost 57 and rightmost 58 edges of the panel 53, such that this will be the image represented by the first and last subdivision panels of the traversing function. The distance from 70% from the right edge panel to 30% into the last screen panel is calculated and rounded up such that the number of subdivision panels required to traverse the complete panel between the first and last will consistently overlap each page between 30% and 50%. Similarly a vertical scrolling calculation can be done so that scrolling vertically yields a similar consistent overlap between panels. In the case where horizontal and vertical traversing is required, both techniques are employed to produce a two dimensional matrix of overlapping panels.

Once the complete graphic image has been reduced to panels of the optimal panel size, a thematic map or panel sequence can then be produced to show the relationship between panels. This map starts as a simple one node per panel graph, but nodes corresponding to horizontal and/or vertical subdivided panels are expanded into one node per subdivision panel of the larger original panel. That is, subdivision panels of a subdivided panel are integrated as a group into the overall panel sequence. This information is used to guide the system from panel to panel through all combinations of navigation inputs. In another preferred embodiment the nodes can be hierarchical in nature, where one node represents the thematic map of the large panel, but it is rendered as shrunk to the size of the device screen. The user may then select to zoom on the panel, and then receive the subdivision panel sequence.

An example of the thematic map 59 which provides a logical and sequential order for displaying the panels is shown as an overlay to the panels in FIG. 6. The first panel 53 is subdivided into five optimally sized panels which move in a sequential traversal order from panel A to panel E. The next panel is panel 50, and so is marked as panel F in the sequence, followed by panel 51, which is marked as panel G in the sequence, etc. It should be noted that while a linear panel sequence is shown in which the panels can be navigated by simple Next Panel/Previous Panel functions, the panel sequence may be two-dimensional or based on other mappings.

In one embodiment, the panelizing application may calculate the panel sequence automatically. For example, the panels are analyzed in a top-to-bottom and left-to-right manner so that a panel in the leftmost and topmost corner is chosen first. The next panel in the sequence may then be chosen by moving right along the topmost line. At the end of the line, the system may choose the next panel by returning to the leftmost edge on following line down. Other paradigms may be used and will be apparent to a person skilled in the art.

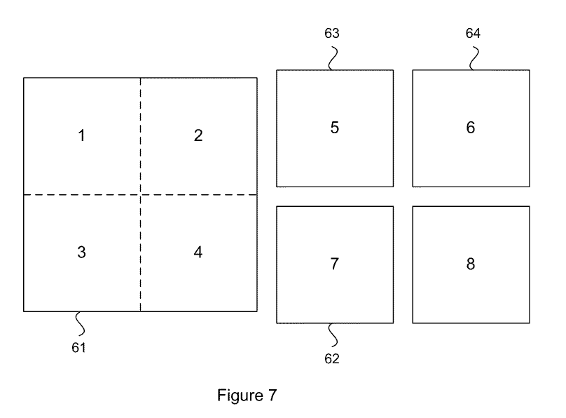

An exception to the top-to-bottom, left-to-right analysis rule (or other utilized analysis rule) may be when subdivided panels are encountered. When the thematic map analysis component of the panelizing application encounters an original image that has been subdivided, the thematic map may perform a nested analysis to ensure that all of the subdivision panels are treated as a group and integrated into the panel sequence prior to the next original panel. This ensures that the meaning of the graphic image is properly conveyed. An example of this process is shown in FIG. 7. An original image is comprised of a first large panel 61 that is positioned to the left of four smaller panels 62. During the conversion process that produces panels of the optimal panel size, panel 61 is subdivided into a 2×2 grid of subdivision panels the same size as the panels 62. There is thus two rows of four panels. If a strict top to bottom, left to right analysis were performed, then the panel order would start with the top most panels of the image 61, followed by the panels 63, 64, then the bottom most panels of the original panel 61. The logical order of the panel viewing would be thus be inaccurate. Instead, by analyzing the subdivided panels of panel 61 as a group and then integrating the subdivision panels as a group into the panel sequence, the logical panel order, shown by the numbers 1 to 8, is maintained.

To assist in grouping of the subdivision panels, the panelization application may store an indicator that a panel has been subdivided from a larger original panel. The indicator may be a simple flag, a reference to the original image, or some other indicator as will be apparent to the person skilled in the art.

The panelization application may be provided with a manual override that receives user input through an interface so that errors in the thematic map may be corrected.

In one embodiment, the thematic map may be produced partly or entirely from user input into an interface that sets the sequential order of the panels.

The panels converted to the optimal panel size and the thematic map 59 are stored in a database or similar storage. The thematic map may be hardcoded into the application or stored as XML data or other machine readable format.

When the original graphic is requested by a display device, such as a mobile display device, the converted panels and the associated thematic map are retrieved from the database and transmitted by a server to the device. When the panels and thematic map are loaded into a display device, the panels can be resized to fit the particular screen so that whole panels are displayed. By displaying whole panels, the need for scrolling is eliminated or at the least reduced. Traversing of the entire original graphic is thus performed on a panel by panel basis, based on a logical sequence dictated by the thematic map, rather than by scrolling a line of pixels at a time.

By including the bold outline of the original panels in the overall array of traversing panels, the outline itself acts as a visual cue to the user that he is seeing all of the image, or that horizontal or vertical traversing is required. Where the bold outline is shown, traversing may be disabled in that direction. Where the outline is not visible, the user may traverse in those directions.

As described above, the display device's usual navigation interface can be utilized with the thematic map to provide panel by panel traversing of the graphic image.

In one embodiment, the image server, e.g. server 14 shown in FIG. 1, upon receiving a request from the display device 18, may retrieve all of the panels and the panel sequence from the database 16 and provided these to the display device 18. Display of the image may then be conducted locally within the device 18 so that navigation commands in the device cause the appropriate panels, stored locally within the device, to be displayed. In an alternative embodiment, when the server 14 receives the request for the image from the display device 18, the server 14 may retrieve a starting panel of the image and provide only the starting panel to the display device. Navigation commands to traverse the image may then be provided from the device 18 to the server 14. The server 14 may interpret the navigation commands in association with the panel sequence and provide the panels only when they are requested from the display device. This embodiment may have advantage by reducing the memory and processing requirements of the display device.

Prior to converting the panels to the optimal panel size, the chosen optimal panel size may be compared against a precomputed or stored list of applicable screen sizes, and a metric used to determine if this size will fit in the screen with simple resizing. If the optimal panel size does not represent an appropriate panel size for screen display, another panel size may be calculated.

It can be seen from the above described embodiments that the panelization method herein described provides quality screen renderings of various types of images such as cartoons or similar graphical images for many types of display devices, along with highly customized and simplified user interface requirements to view the cartoon or other graphical image.

The system and methods as herein described may be embodied in computer software, computer hardware and/or a combination of computer software and computer hardware. In a computer software embodiment, the panelization application may comprises a set of program instructions that may be stored in a computer memory device. The computer memory device may be read by one or more computer processors to execute the application.

Although the description above contains many specifications, these should not be construed as limiting the scope of the invention but as merely providing illustrations of some of the embodiments of this invention. Thus, the scope of the invention should be determined by the appended claims and their legal equivalents rather than by the examples given.

What is claimed is:

1. A method for panelizing an image comprising:
(A) locating a first plurality of panels within an image;
(B) determining an optimal panel size;
(C) converting the first plurality of panels to a second plurality of panels of the optimal panel size;
(D) determining a sequence of the second plurality of panels; and
(E) storing the second plurality of panels in association with the sequence of the second plurality of panels.

2. The method of claim 1 wherein determining the optimal panel size comprises determining the most common panel size of the first plurality of panels.

3. The method of claim 1 wherein locating the first plurality of panels comprises executing an algorithm on a computer processor to locate the first plurality of panels.

4. The method of claim 1 wherein determining the optimal panel size comprises executing an algorithm on a computer processor to determine the optimal panel size.

5. The method of claim 1 wherein locating the first plurality of panels comprises locating corners within the image.

6. The method of claim 1 wherein locating the first plurality of panels comprises locating bounding boxes within the image.

7. The method of claim 1 wherein converting the first plurality of panels to the second plurality of panels comprises subdividing at least one of the first plurality of panels into a plurality of subdivision panels of the optimal panel size.

8. The method of claim 7 wherein subdividing a panel of the first plurality of panels comprises dividing the panel to be subdivided into a plurality of overlapping subdivision panels.

9. The method of claim 7 wherein determining the sequence of the second plurality of panels comprises:
(A) determining a sequence of the subdivision panels; and
(B) integrating the sequence of subdivision panels as a group into the sequence of panels.

10. A system for panelizing an image comprising:
(A) an application executable on at least one computer processor, the application configured to:
(a) locate a first plurality of panels within an electronic image;
(b) determine an optimal panel size;
(c) convert the first plurality of panels to a second plurality of panels of the optimal panel size;
(d) determine a sequence of the second plurality of panels; and
(e) store the second plurality of panels in association with the sequence of the second plurality of panels.

11. A system for providing an image to a display device comprising:
(A) a database that stores a plurality of panels corresponding to the image and a panel sequence corresponding to the plurality of panels; and
(B) a server configured to:
(a) receive a request for the image from a display device;
(b) retrieve at least one panel of the image from the database; and
(c) provide the at least one panel to the display device.

12. The system of claim 11 wherein the server is configured to:
(A) retrieve all of the plurality of panels corresponding to the image and the panel sequence from the database; and
(B) provide the plurality of panels and the panel sequence to the display device.

13. The system of claim 11 wherein the server is configured to:
(A) receive a navigation command from the display device;
(B) reference the panel sequence to determine a next panel corresponding to the navigation command;
(C) retrieve the next panel from the database; and
(D) provide the next panel to the display device.

14. The system of claim 11 wherein the database stores the plurality of panels at an optimal panel size.

15. The system of claim 11 wherein the server is configured to:
(A) determine a screen size of the requesting display device; and
(B) size the at least one panel to match the screen size.

16. A method for providing an image to a display device comprising:
(A) dividing the image into a plurality of panels;
(B) determining a sequence of the panels; and
(C) providing the panels and a panel sequence to the display device.

17. The method of claim 16 comprising:
(A) determining a screen size of the display device; and
(B) resizing the plurality of panels to match the screen size.

18. A method for displaying an image on a mobile display device comprising:
(A) requesting the image from a server;
(B) receiving an initial panel of a plurality of panels corresponding to the image from the server;
(C) displaying the initial panel; and
(D) processing one or more navigation commands with reference to a panel sequence to cause one or more other panels of the plurality of panels to be displayed.

19. The method of claim 18 comprising receiving the panel sequence in the mobile display device from the server.

20. The method of claim 18 comprising providing the one or more navigation commands to the server and receiving the one or more other panels from the server in response to the one or more navigation commands.

21. The method of claim 18 wherein the panels are sized to match a size of a display screen of the mobile display device.
